(19) United States
(12) Patent Application Publication
(10) Pub. No.: US 2012/0103184 A1
(43) Pub. Date: May 3, 2012

(54) ELECTROSTATIC FILTRATION SYSTEM

(75) Inventor: Xinli JIA, Potsdam, NY (US)

(73) Assignee: CLARKSON UNIVERSITY, Potsdam, NY (US)

(21) Appl. No.: 13/288,018

(22) Filed: Nov. 2, 2011

Related U.S. Application Data
(60) Provisional application No. 61/409,178, filed on Nov. 2, 2010.

(51) Int. Cl. B03C 3/47; B03C 3/011; B03C 3/019

(52) U.S. Cl. 95/6; 96/70; 96/55; 96/22; 95/78; 95/63; 95/70; 95/69

(57) ABSTRACT

This application describes a method and apparatus for removing a wide range of particles from a source of gas flow or separation of particulates from dust, mist, or vapor generating devices. An innovative use of open porous materials, which causes little pressure drop, in combination with an electrostatic grids structure is described. The apparatus is capable of removing particulates in the size range 0.01 to 1 micrometer with efficiencies as high as 99.5%. A key feature of the apparatus is that the air to be purified flows parallel to the filters instead of through them, which results in very low power consumption.

### CROSS REFERENCE

This application is related to provisional application No. 61/409,178 filed on Nov. 2, 2010 entitled A Grid Electrostatic Filter (GEF) with Low Pressure Drop and is hereby incorporated herein in full by reference.

### FIELD OF INVENTION

This invention relates to air filtration systems and in particular devices including but not limited to dust filters, electrostatic precipitators, grid electrostatic precipitators, electrostatic filters, air purifiers, or vacuum cleaners.

### BACKGROUND

Fine particle pollutants are known to be a serious health and safety risk to the U.S. population and industrial workers. For example, industrial fumes, including welding fumes, diesel exhaust, and natural indoor air pollutants are known to contain a variety of particulate and gaseous compounds which have direct relationships to health problems ranging from headache to respiratory infections, asthma, and lung cancer.

HEPA, bag, and other types of filters are widely used in many different air purification systems including metal fabrication plants, coal burning plants, diesel engines where the resulting fumes are regulated, industrial clean rooms, and hospitals in areas where the internal environment and air quality are measured.

Electrostatic precipitators and electric sieves are also used in the field of separator apparatuses and collectors for particles that have a variety of electrical properties.

U.S. Pat. No. 4,172,028 discloses an electrostatic sieve having parallel sieve electrodes that are either vertical or inclined. The particles are normally introduced into the electric sieve under the control for a feeder that is placed directly in front of the opposing screen electrode. The collected fine powder is attracted directly from the feeder tray to the opposing screen electrode by an induced electric field that exists between the tray and the screen electrode. This system is a static air system.

U.S. Pat. No. 6,585,803 discloses an electrically enhanced electrostatic precipitator with a grounded stainless steel collector electrode. Particles flow through, rather than parallel to, the collection plate. The utilization of the stainless steel fiber filter provides (1) low particle penetration (high particle collection efficiency), (2) applicability to all different particulate components, (3) high loading capacity but low pressure drop, (5) low electric voltage for operating the system, and (6) low cost and small dimension.

U.S. Pat. No. 7,316,735 discloses a cylindrical dust collector in which air flows through a filter in an annulus. A secondary flow is created that forces air into a porous filter material that lines the outer wall of the cylinder. The secondary flow transports particles into the filter material.

U.S. Pat. No. 7,582,144 discloses a space efficient hybrid air purifier in which the collector electrode is made of porous filter material. Air is forced through the filter material into an exit area for further cleaning.

U.S. Pat. No. 7,332,019 discloses an air filtration system included in and for HVAC equipment that includes one or more intense field dielectric filter units and a field charging unit retained in a support structure or cabinet. Each filter unit includes a filter core comprising a stacked array of filter elements formed of dielectric sheets interconnected by elongated spaced apart ribs forming flow passages. The air is forced through the filters.

U.S. Pat. No. 6,773,489 discloses a grid electrostatic collector/separator that removes particles from an air stream. The described apparatus includes multiple parallel grids that act as the porous material enclosed in a sealed compartment in which the entrained air flows parallel to the grids. A direct current high voltage field is established between grids with the option of alternating polarities. Particles carried by the air stream are charged as they flow through the apparatus, and are separated and collected when attracted toward the grid having opposite polarity, which has a relatively open structure, and pass laterally through and onto the collecting plates.

U.S. Pat. No. 7,105,041 discloses a related grid electrostatic collector/separator that removes particles from an air stream, in which both internal and external corona discharge methods are used when non-conductive particles are present.

U.S. Pat. No. 7,585,352 discloses a method to improve the separation and collection of particulates from dust, mist or vapor by electrically charging the particulates in the described apparatus, in which a grid electrostatic precipitator in combination with a corona pre-charge is used to remove fine particles.

U.S. Pat. No. 4,778,493 discloses an electrical precipitator that efficiently enhances fine particle charging by means of a combination of field charging, diffusion charging, and electron charging for the enhancement of fine particle collection. The diffusion charging and electron charging are used to increase the charge on fine particles that are smaller than 1 micrometer so that the particles can be efficiently collected by electrostatic precipitation. The field charging is used to efficiently precipitate particles that are larger than 1 micrometer in diameter; the removal of such particles prevents them from interfering with the collection of the finer particles.

Prior art precipitators and sieves have difficulty collecting particulate matter with very high or very low conductivity, and they also lack the ability 1, achieve high collection efficiency for fine particles. Some prior art technology uses the combination of corona discharge and filtration to achieve higher efficiency for fine particles, but air has to be blown through filters, so the resulting high pressure drop and energy consumption are inevitable. The disclosed embodiments below overcome these deficiencies.

### SUMMARY

This application discloses a method of and an air filtration system with a grid-open porous structure used as an electrode and a collection means for a high efficiency, low energy consumption electrostatic precipitator.

By using an open pore structure material (filter material, knitted metal, etc.) together with grid electrodes within a high voltage electric field, it is possible to achieve higher collection efficiencies (>99%) of particulate matter in a gas flow that is otherwise impossible. Comparing to traditional filter or precipitator technology, the invented assembly of grid electrode and open porous structure for the new air filtration system can achieve equal or higher efficiency while greatly reducing the associated energy consumption and disposal of used filters.

This application describes a method and apparatus for removing a wide range of particles from a source of gas flow or separation of particulates from dust, mist, or vapor generating devices. An innovative use of open porous materials, which causes little pressure drop, in combination with an electrostatic grids structure is described. The apparatus is capable of removing particulates in the size range 0.01 to 1 micrometer with efficiencies as high as 99.5%. A key feature of the apparatus is that the air to be purified flows parallel to the filters instead of through them, which results in very low power consumption.

### BRIEF DESCRIPTION OF THE DRAWINGS

These and other features, aspects, and advantages of the present invention will become better understood with regard to the following description, appended claims, and accompanying drawings where:

FIG. 1 illustrates a vertical cross sectional view of an embodiment of the invention;

FIG. 2 illustrates a cross sectional view showing the charged particles passing through the grid aperture of the grid electrode;

FIG. 3 illustrates the removal of the porous collector separately, as opposed to removing the grid filter assembly;

FIG. 4 illustrates the placement of the various sections of the precipitator.

### DETAILED DESCRIPTION

The embodiments of the invention comprise an electrostatic filtration system using a layer of open pore structure material (filter material, knitted metal, glass fiber, etc.) adjacent or behind the grid electrodes, or between grid electrode and collecting plate within an electric field, it is possible to achieve higher collection efficiencies (>99.5%) of particulate matter in a gas flow that is otherwise very difficult, if not impossible. The electric field is created by a DC voltage applied to the precipitator.

This embodiment of the invention can be used with either a single or multiple moving gas streams that are entrained and in contact with grid-porous media structures. The fine particle laden gas stream will flow through the parallel channels between a pair of grid-porous media electrodes that also serve as collection plates. When an electric voltage is applied between grid filters, a direct current field is also established. The charged particulates in the gas flow will be driven to move laterally cross the general flow direction due to the force of the electric field. The effective voltage used to create depends on the distance between discharge electrode and grid-porous media electrode, and the electrical properties of gas stream and particles in the gas stream. Given enough residence time, said particles will reach at least one of said grid-porous media electrodes for collection. The residence time depends on several factors, including the main gas stream velocity, the strength of the electrical field, the distance between discharge electrode and the collecting electrode, and the particle size and electrical property.

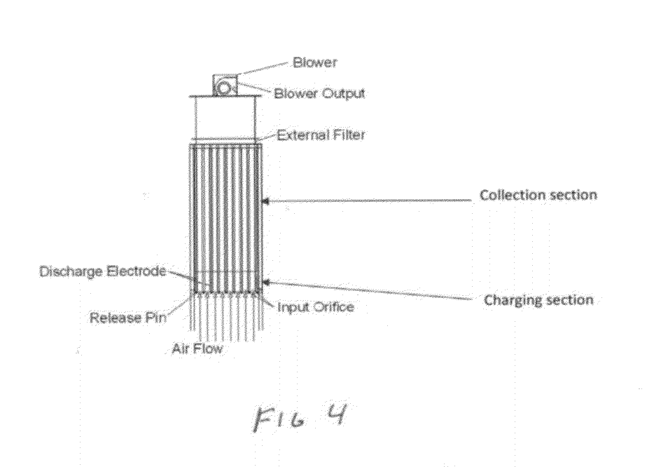

FIG. 4 illustrates the various sections of a precipitator system. Particles that enter the collecting area or section can be captured by, but not limited to, the surface of open pore structure, the fibers of a filter, a knitted metal structure, a glass fiber, or any other like structure. This embodiment of the invention greatly reduces particle re-entrainment with very low pressure drop, and thus greatly improves the efficiency of collecting fine particles.

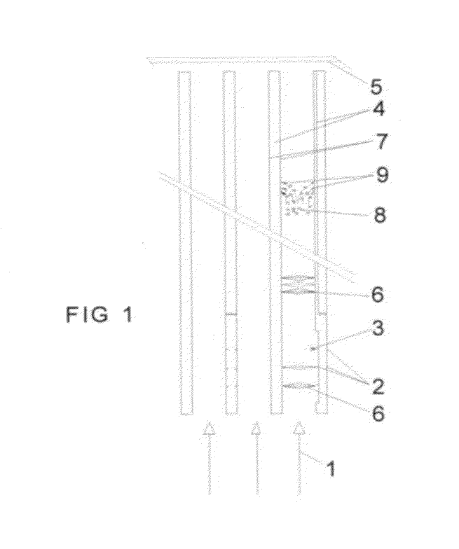

The design of the precipitator with a new grid-open porous structure can have several operating modes. FIG. 1 illustrates a vertical cross sectional view of one embodiment that divides the device into three zones. The first zone initially draws the entrained air (1) past discharge electrodes (2) where the particulates (8) are charged and then move into the high voltage grid-open porous collection section (4) and then through the final filter (5). Another version has the discharge electrodes (2) prior to the high voltage grid filter section (4) and the final filter, which is optional, after grid-open porous collecting section.

The invented precipitator with a new grid-open porous structure functions by generating an electrical field (6) between parallel grids (7) causing the charged particles (8) to follow the flux lines that are generated by the electric field (6) and flow laterally (9) towards the conductive grid, and then can be captured by the surface of open pore structure, the fibers of a filter, a knitted metal structure, a glass fiber, or any other like structure. The internal structure used between the grids is not limited to the structures described. Any mesh or porous type of material that reduces air movement and provides surface area for particle collection may be used. The material used can be either conductive or nonconductive.

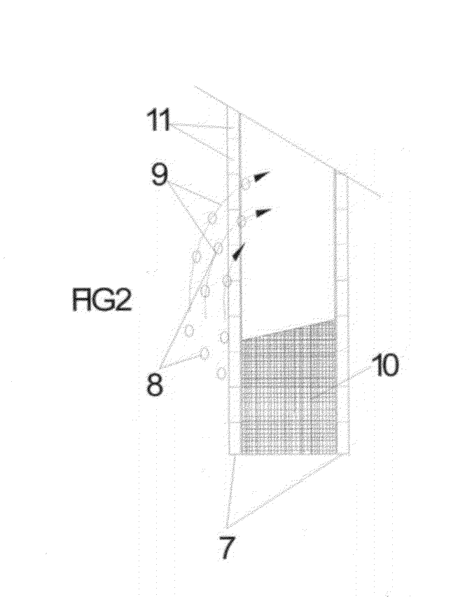

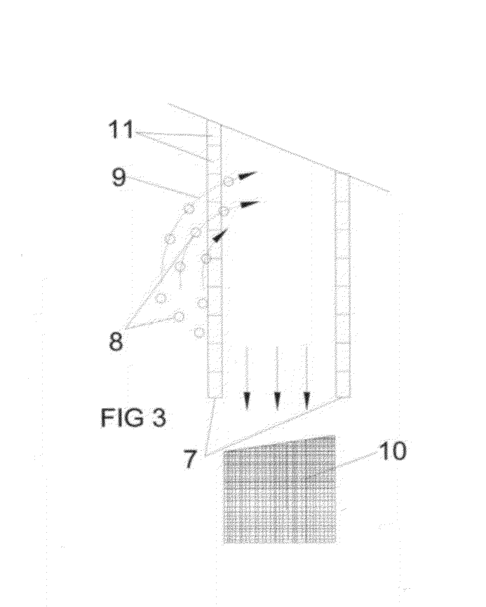

FIG. 2 is a cross sectional view showing the charged particles (8) passing through the grid aperture (11) of the grid electrode (7) into the porous collector (10). FIG. 3 is similar to FIG. 2 with the exception of removing just the porous collector (10) separately, as opposed to removing the grid filter assembly.

The major difference between the invented air filtration technology and standard filter technology is that the gas stream does not flow through the filter material, instead, it flows parallel to its surface. This results in a very low pressure drop. Yet the existence of electric field on the precipitator gives it the ability to collect fine particles (0.03 micron) efficiently (>99%) using relatively coarse porous collectors.

The broad scope of this process includes: A method to deliver purified air to cleanrooms or residential buildings, or work areas such as welding bays, grinding areas, or other like areas where fine metals are generated, or places close to the exhaust of diesel engines or alike. The invented air filtration system has collection efficiency close to that of HEPA filters, with negligible pressure drop because there is no longer a need to force air through the fine pores on HEPA filters, which results in a much lower energy consumption; It is a more durable technique which requires relatively minor periodic maintenance; and It can be used to remove industrial vapors.

In conclusion, this application describes a method and apparatus for removing a wide range of particles from a source of gas flow or separation of particulates from dust, mist, or vapor generating devices. An innovative use of open porous materials, which causes little pressure drop, in combination with an electrostatic grids structure is described. The apparatus is capable of removing particulates in the size range 0.01 to 1 micrometer with efficiencies as high as 99.5%. A key feature of the apparatus is that the air to be purified flows parallel to the filters instead of through them, which results in very low power consumption.

The illustrative embodiments and modifications thereto described hereinabove are merely exemplary. It is understood that other modifications to the illustrative embodiments will readily occur to persons of ordinary skill in the art. All such modifications and variations are deemed to be within the scope and spirit of the present invention as will be defined by the accompanying claims.

I claim:

1. An electrostatic precipitator comprising:
one or more fine particle-laden gas streams flowing through one or more parallel channels between a pair of grid filter electrodes that also serve as collection plates;
an electric field that is applied between said grid filters,
a direct current field that is also established;
said particulates in said gas flow are driven to move laterally across a general flow direction due to a force of said electric field and a corona wind created by the electric field; and
given enough residence time, said particles reach at least one of said grid filters for collection.

2. The precipitator of claim 1 wherein said residence time depends on several factors, including:
a main gas stream velocity,
strength of said electrical field,
a distance between a discharge electrode and said collecting electrode, and
a particle size and electrical property.

3. The precipitator of claim 1 further comprising:
an input orifice;
a charging section;
a collection section; and
an output section.

4. The precipitator of claim 3 wherein said input orifice provides an input of said precipitator for said gas containing said particulants.

5. The precipitator of claim 3 wherein said charging section

6. The precipitator of claim 3 wherein said collection section

7. The precipitator of claim 3 wherein said output section may include

8. The precipitator of claim 1 comprising:
an open porous material selected from the group consisting of filter material, knitted metal and glass fiber.

9. The precipitator of claim 1 wherein said particulates in said gas flow are driven laterally across a general flow direction.

10. The precipitator of claim 1 wherein said system to achieves collection efficiencies greater than 99.5% of particulate matter in said gas flow

11. The precipitator of claim 1 wherein said charged particulates in said gas flow are driven to move laterally cross a general flow direction due to said force of said electric field.

12. The precipitator of claim 1 wherein an effective voltage used to create an electric field depends on a distance between discharge electrode and grid-porous media electrode; and electrical properties of said gas stream and particles within said gas stream.

13. The precipitator of claim 1 wherein said particles that enter a collecting area are captured by said surface of open pore structure, using said fibers of a filter, said knitted metal structure, a glass fiber, or any other like structure.

14. The precipitator of claim 1 wherein having a grid-open porous structure, functions by generating an electrical field between parallel grids causing said charged particles to follow a plurality of flux lines that are generated by said electric field and flow laterally towards a conductive grid, and then are captured by a surface of said open pore structure, including fibers of a filter, a knitted metal structure, a glass fiber, or any other like structure.

15. The precipitator of claim 3 wherein said charging section initially draws said entrained air past said discharge electrodes where said particulates are charged and then move into said high voltage grid-open porous collection section and then through a final filter

16. The precipitator of claim 1 wherein said discharge electrodes are placed prior to a high voltage grid filter section and an optional filter final filter, and after said grid-open porous collecting section.

17. A method for collecting particles from a fine particle-laden gas stream comprising the acts of:
providing a fine particle laden gas stream;
flowing said stream through one or more parallel channels between a pair of grid filter electrodes that also serve as collection plates;
applying an electric field applied between said grid filters,
establishing a direct current field;
driving said particulates in said gas flow to move laterally cross a general flow direction due to a force of said electric field and a corona wind created by the electric field; and:
allowing sufficient residence time, for said particles to reach at least one of said grid filters for collection.

18. The method of claim 17 wherein said residence time depends on several factors, including:
a main gas stream velocity,
strength of said electrical field,
a distance between discharge electrode and said collecting electrode, and
a particle size and electrical property.

19. The method of 17 further comprising the acts of:
providing an input orifice;
providing a charging section;
providing a collection section; and
providing output section.

20. The method of claim 19 further comprising the acts of:
providing said input orifice provides an input of said precipitator for said gas containing particulants.

21. The method of claim 17 comprising the acts of:
providing an open porous material selected from the group consisting of filter material, knitted metal and glass fiber.

22. The method of claim 17 comprising the acts of:
driving said particulates in said gas flow laterally across a general flow direction.

23. The method of claim 22 wherein said charged particulates in said gas flow are driven to move laterally cross a general flow direction due to said force of said electric field.

24. The method of claim 23 wherein an effective voltage used to create an electric field depends on a distance between discharge electrode and grid-porous media electrode; and electrical properties of said gas stream and particles within said gas stream.

25. The method of claim 18 wherein said method achieves collection efficiencies greater than 99.5% of particulate matter in said gas flow.

26. The method of claim 18 comprising the acts of:
capturing said particles that enter a collecting area by using said surface of open pore structure, fibers of a filter, a knitted metal structure, a glass fiber, or any other like structure.

27. The method of claim 18 comprising the acts of:
having a grid-open porous structure and generating an electrical field between parallel grids causing said charged particles to follow a plurality of flux lines that are generated by said electric field and flow laterally towards a conductive grid, and then are captured by a surface of said open pore structure, including fibers of a filter, a knitted metal structure, a glass fiber, or any other like structure.

28. The method of claim 19 comprising the acts of:
drawings said entrained air past said discharge electrodes where said particulates are charged and then move into said high voltage grid-open porous collection section and then through a final filter.

29. The method of claim 18 comprising the steps of:
placing said discharge electrodes prior to said high voltage grid filter section and said final filter, and after said grid-open porous collecting section.
